(19) United States
(12) Patent Application Publication
(10) Pub. No.: US 2023/0385391 A1
(43) Pub. Date: Nov. 30, 2023

(54) METHOD AND DEVICE FOR REMOTELY SIGNING AND CERTIFYING A PERSON'S IDENTIFICATION DATA

(71) Applicant: ADVANCED TRACK & TRACE, Rueil-Malmaison (FR)

(72) Inventors: Zbigniew SAGAN, Rueil-Malmaison (FR); Jean-Pierre MASSICOT, Rueil-Malmaison (FR)

(21) Appl. No.: 18/248,875

(22) PCT Filed: Oct. 13, 2021
(86) PCT No.: PCT/EP2021/078337

§ 371 Date: Apr. 13, 2023

(30) Foreign Application Priority Data
Oct. 13, 2020 (FR) FR2010475
Dec. 7, 2020 (FR) FR2012792

(51) Int. Cl. G06F 21/32; G06K 19/06

(52) U.S. Cl. CPC G06F 21/32; G06K 19/06037

(57) ABSTRACT

The method (10) for the remote signature and certification of a person's identification data, comprises:
by a communicating mobile terminal:
   a step (12, 14) of reading a machine-readable zone, in an official document, a zone reserved for the reading, identification and validation of this document,
   a step (16) of reading, in a memory of this official document, a photograph and a signature of said photograph, and
   a step (20, 22) of transmitting the photograph and the signature of the photograph to a remote server; and
by the remote server:
   a step (26) of calculating a facial recognition template from the photograph.

### TECHNICAL FIELD OF THE INVENTION

The present invention relates to a method and a device for the remote signature and certification of a person's identification data. It applies, in particular, to the remote signature and certification of data in the field of Digital Travel Credentials (“DTC”).

### STATE OF THE ART

It is important to continue to reinforce the borders and improve travellers' experience. In recent years, the technology has evolved dramatically in fields such as identity, security, biometry and mobile applications to do this. Technology has already transformed the world of border security and the effective handling of passengers, for example, thanks to secure electronic passports (also known as electronic Machine Readable Travel Documents or eMRTDs), automated electronic gates, the biometrics used to ensure the visa regimes and mobile boarding passes.

A new generation of safe, effective solutions is only just beginning with the development of digital travel credentials (DTCs).

DTC is a new concept, but it is based on the existing standards and comprises two portions:
a physical component equipped with cryptographic and communication capabilities, such as an epassport, a mobile telephone or a smart watch. This is carried by the traveller as proof of possession to identify the passenger, and it also indicates:
a matching virtual component. In other words, data held remotely to which a designated authority can have access in complete security.

Standards, technologies and practices are being drawn up to make DTC a reality—the first DTC standard should be published by the International Civil Aviation Organisation (ICAO) during 2020. This standard should combine the existing eMRTD, as specified in ICAO document 9303, as a physical component, and a new virtual component defined in a new DTC standard.

DTC will be at the centre of a new generation of border management systems that strengthen security while speeding up the passengers' journey through the airport and across borders.

In collaboration with the International Organisation for Standardisation (ISO), the ICAO's New Technologies Working Group (NTWG) is tasked with the standardisation of the DTC—firstly, to add a digital companion to the epassport, and then to evolve in order to provide a substitute when the authentication and verification of passengers are migrated to the mobile device.

The DTC will supply a digital representation of the traveller's identity, which can then be validated using the public key infrastructure of the authority issuing the travel document.

The DTC is therefore based on the passport and is the property of the government.

While the DTC will offer an effective virtual substitute, the ICAO has made it very clear that the epassport must be considered the reference with regard to development—the DTC reflecting the reliable, portable and verifiable attributes of its physical cousin. The ICAO framework is particularly clear about the principle of ownership. The DTC will be the property of the authority issuing the travel document, and the resulting data are held by, and the responsibility of, the sovereign governments.

Identification of the DTC Formats

There are three DTC formats, based on a hybrid model. Each is made up of a virtual component (DTC-VC), which is essentially a data file, and a physical component (DTC-PC), i.e. some object that you have, such as an eMRTD or a smart device. The DTC-VC and DTC-PC are linked cryptographically, all the respective public keys being contained in the DTC-VC. The three formats are:
eMRTD-bound. In this format, the virtual component is “linked” to the epassport (i.e. it contains a partial copy of the biographic and biometric facial data contained in the epassport). This allows the traveller to be identified solely based on the DTC-VC—although he must carry his passport so he can present it in the case where identification fails and he must prove possession of a passport.
eMRTD-PC-bound. In this format, the virtual element (containing the identity data described above) is located on the physical element—the smartphone or mobile device. The travellers use these devices if they have to prove that they possess a passport, so that they do not have to carry the passport on them. Although the VC can be stored on the physical component, this is not mandatory. The VC can also be used on its own as proof of identity by being made available to players in the travel sector (airline, airport, border, etc.) before the journey.
PC-bound. In this case, the virtual component is located on the smart device and can have its own document characteristics—for example, the passport number, period of validity, digital signature, etc. It can be used by the travellers without need for an epassport, and the citizens having this DTC can therefore freely share their virtual component with whomever they want, to prove their identity.

However, deployment of the DTCs poses a number of problems.

The authorities of a country receiving foreigners often need to establish a visa ahead of time or to establish the data referred to as Digital Travel Credentials (DTC). But this step requires an in-person meeting, and therefore the traveller has to physically visit the consulate of the destination country.

Furthermore, since the DTC handles personal data, this poses the problem of the traveller's control of his personal data.

### PRESENTATION OF THE INVENTION

The present invention aims to remedy all or part of these drawbacks.

To this end, according to a first aspect, the present invention relates to a method for the remote signature and certification of a person's identification data, which method comprises the following steps:

by a communicating mobile terminal:
a step of reading a machine-readable zone, in an official document, a zone reserved for the reading, identification and validation of this document,
a step of reading, from a memory in this official document, a photograph and a signature of said photograph, and
a step of transmitting the photograph and the signature of the photograph to a remote server; and

by the remote server:
a step of calculating a facial recognition template from the photograph.

Thanks to these provisions, the user controls his personal data, and the authorities of the destination country control the process of generating the facial recognition template which helps to saves time when the traveller arrives.

In some embodiments:
a) the step of reading a machine-readable zone, in an official document, comprises a step of taking an image of the data page of a biometric passport, and a step of processing the captured image providing a key for accessing an electronic memory of the passport;
b) during the step of reading, from a memory in this official document, a photograph and a signature of said photograph, the communicating mobile terminal also reads the user's personal data and the electronic signature of these data;
c) the method also comprises a step of the communicating mobile terminal verifying the face match between:
   the user, whose image is captured by the communicating mobile terminal,
   the photograph visible in the data page of the passport, and/or
   the photograph stored in the electronic memory of the passport;
d) the method also comprises a step of the communicating mobile terminal verifying the biometric data correspondence between:
   the user, whose biometric data are captured by the communicating mobile terminal,
   the equivalent biometric data in the data page of the passport, and/or
   the biometric data stored in the electronic memory of the passport;
e) the method comprises, before the step of transmitting the photograph and the signature of the photograph to a remote server, a step of encrypting these data with the public key of the country selected by the user;
f) the method comprises, after the step of calculating a facial recognition template from the photograph, a step of encrypting the template and transmitting the encrypted template to the communicating mobile terminal;
g) the method comprises, after the step of calculating a facial recognition template from the photograph, a step of calculating a hash of the data corresponding to the passport's data and the administrative data, including the facial recognition template of the country selected by the user; and/or
h) the method comprises, after the step of calculating a hash, a step of encoding the hash according to a two-dimensional code, for example a visible electronic stamp, and the signature of the two-dimensional code, including the template, with the certificate of the country selected by the user, and a step of transmitting the two-dimensional code to the communicating mobile terminal.

According to a second aspect, the present invention relates to a device for the remote signature and certification of a person's identification data, which device comprises:
a communicating mobile terminal configured to:
   read a machine-readable zone, in an official document, which zone is reserved for the reading, identification and validation of this document;
   read, from a memory in this official document, a photograph and a signature of said photograph; and
   transmit the photograph and the signature of the photograph to a remote server; and the remote server being configured to calculate a facial recognition template from the photograph.

As the features, advantages and aims of this device are similar to those of the method that is the subject of the present invention, they are not repeated here.

### BRIEF DESCRIPTION OF THE FIGURES

Other advantages, aims and particular features of the invention will become apparent from the non-limiting description that follows of at least one particular embodiment of the method and the device that are the subjects of the present invention, with reference to drawings included in an appendix, wherein:

FIG. 1 represents, in the form of a logical diagram, steps utilised in the method that is the subject of this invention, and

FIG. 2 represents, schematically, a device that is the subject of the present invention.

### DESCRIPTION OF THE EMBODIMENTS

The present description is given in a non-limiting way, in which each characteristic of an embodiment can be combined with any other characteristic of any other embodiment in an advantageous way.

Note that the figures are not to scale.

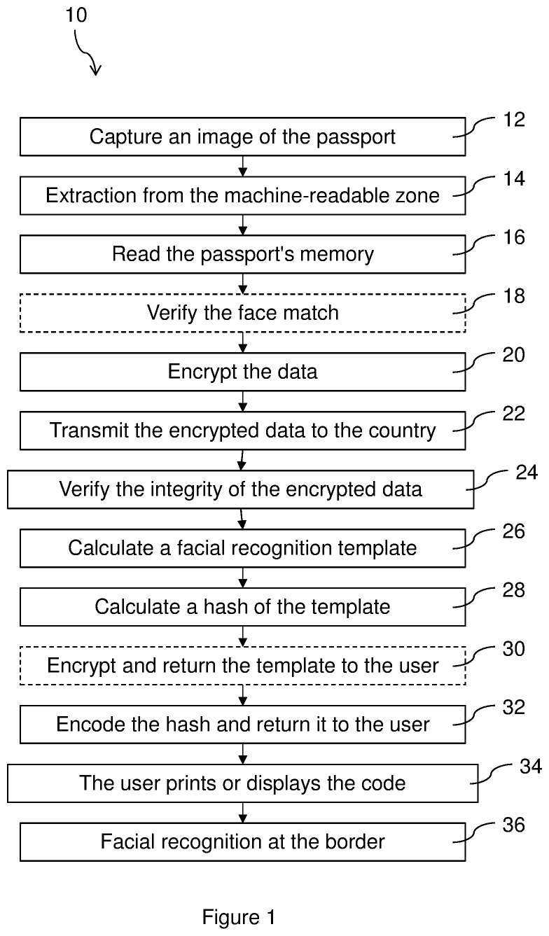

FIG. 1 shows, in a method 10, a step 12 of using a communicating mobile terminal, typically a smartphone, to take an image of the data page of a biometric passport. The communicating mobile terminal is equipped with software, typically an application dedicated to the utilisation of the present invention, which processes the captured image, during a step 14. This processing carries out an extraction from the MRZ and obtains a key for accessing the passport's electronic memory (“chip”). Note that a machine-readable zone (MRZ) or optical scanning zone is a zone, in an official document, reserved for the reading, identification and validation of this document.

During a step 16, the application commands a reading of the passport's electronic memory (“chip”), with an RFID (acronym for Radio Frequency Identification) reader to retrieve:
the identity photograph of the user;
the personal data of the user (date and place of birth, height and eye colour, for example);
the electronic signature of these data.

Optionally, during a step 18, the application verifies the face match between:
the user of the communicating mobile terminal, for example by using an image capture device that it includes;
the photograph visible in the data page of the passport and/or
the photograph stored in the electronic memory of the passport.

The recognition of the user's face, by means of facial recognition, has the advantage of checking whether the general data protection regulation (GDPR) is applicable since the user is identified. Alternatively, other biometric data are used, such as the fingerprint.

Before step 20, the user selects a destination country with his communicating portable terminal.

During a step 20, the application encrypts all the data with the public key of the country the user wants to travel to.

During a step 22, the application carries out the transmission to a Webservice of this country.

During a step 24, the authorities of this country carry out a data integrity check, for example by utilising the PKD ICAO infrastructure with the host country certificate.

During a step 26, a server calculates a facial recognition template based on the passport's photograph.

During a step 28, this server calculates a hash of the data corresponding to the passport's data and the administrative data, including the facial recognition template of the receiving country.

Optionally, during a step 30, the template is encrypted and returned to the user, with a view to decryption when this user arrives at the border of the receiving country.

During a step 32, the hash is encoded according to a two-dimensional (“2D”) code, for example a visible electronic stamp (acronym “VES”), signed, including the template, with the certificate of the receiving country, and sent to the user, the holder of the passport, in the application hosted by the communicating mobile terminal or via email.

During a step 34, the user carries out a print of the 2D code or a display on the screen of the communicating mobile terminal.

During a step 36, during the control at the border of the destination country, facial recognition is carried out using the 2D code presented by the holder.

As is easily understood, the present invention saves time for the user, who no longer has to go to the consulate or embassy of the destination country, and for this country's authorities.

Note that facial recognition of the user based on the template is entirely under the control of the user's destination country.

Therefore, the authorities of a country receiving foreigners no longer have to establish a visa ahead of time or establish the data referred to as Digital Travel Credentials (DTC).

The utilisation of the invention makes it possible to produce these data without an in-person meeting that requires the traveller to physically visit the consulate of the receiving country.

Data from an epassport are used under the entire control of the passport holder because he carries out the image capture for the passport, and with a biometric verification of the passport holder.

For its part, the destination country controls the application or Trusted Point of Entry (TPE) since it issues it, the chosen trusted network of this country, and the encrypted VES.

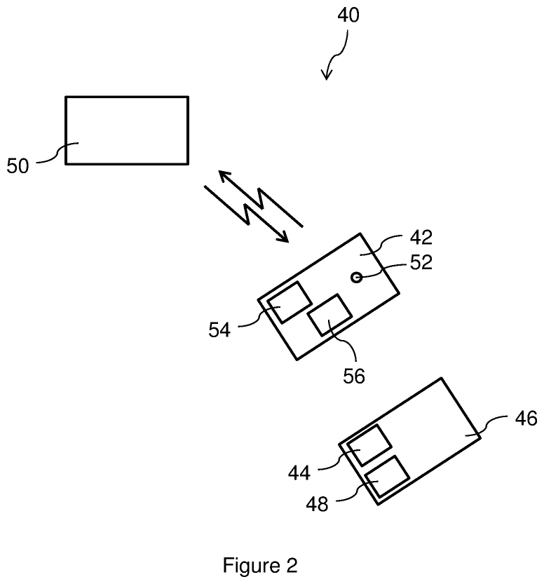

The device 40 for the remote signature and certification of a person's identification data illustrated in FIG. 2, comprises a communicating mobile terminal 42 comprising an image capture device 52 configured for reading a machine-readable zone 44, in an official document 46, here a biometric passport.

The communicating mobile terminal 42 comprises a software memory 54, which holds an application dedicated to the utilisation of the present invention.

This application processes the captured image, carries out an extraction from the MRZ and obtains a key for accessing the electronic memory (“chip”) of the passport.

The terminal 42 also comprises a reader 56, for example RFID, in an electronic memory 48 of the official document 46, of at least one photograph and a signature of said photograph.

Preferably, the terminal 42 reads, from the memory 48:
the identity photograph of the user;
the personal data of the user (date and place of birth, height and eye colour, for example);
the electronic signature of these data.

Optionally, the terminal 42 verifies the face match between:
the user of the communicating mobile terminal, for example by using an image capture device that it includes;
the photograph visible in the data page of the passport and/or
the photograph stored in the electronic memory of the passport.

Alternatively, other biometric data are used for this correspondence verification, such as the fingerprint of the user.

The terminal 42 is configured to transmit the photograph and the signature of the photograph to a remote server 50.

The terminal 42 carries out steps 20 and 22 described above.

The remote server 50 of the destination country to which the terminal 42 sends the encrypted data is configured to calculate a facial recognition template based on the photograph received from the terminal 42. The server 50 carries out steps 24 to 32 described above.

1. A method for the remote signature and certification of a person's identification data, comprising:
by a communicating mobile terminal:
a step of reading a machine-readable zone, in an official document, a zone reserved for the reading, identification and validation of this document,
a step of reading, in a memory of this official document, a photograph and a signature of said photograph, and
a step of transmitting the photograph and the signature of the photograph to a remote server; and
by the remote server:
a step of calculating a facial recognition template from the photograph,
a step of calculating a hash of the data corresponding to the passport's data and the administrative data, including the facial recognition template of the country selected by the user,
a step of encoding the hash according to a two-dimensional code, for example a visible electronic stamp, and the signature of the two-dimensional code, including the template, with the certificate of the country selected by the user, and
a step of transmitting the two-dimensional code to the communicating mobile terminal.

2. The method according to claim 1, wherein the step of reading a machine-readable zone, in an official document, comprises a step of taking an image of the data page of a biometric passport, and a step of processing the captured image providing a key for accessing an electronic memory of the passport.

3. The method according to claim 1, wherein, during the step of reading, from a memory in this official document, a photograph and a signature of said photograph, the communicating mobile terminal also reads the user's personal data and the electronic signature of these data.

4. The method according to claim 1, which also comprises a step of the communicating mobile terminal verifying the face match between:
the user, whose image is captured by the communicating mobile terminal,
the photograph visible in the data page of the passport and/or
the photograph stored in the electronic memory of the passport.

5. The method according to claim 1, which also comprises a step of the communicating mobile terminal verifying the biometric data correspondence between:
the user, whose biometric data are captured by the communicating mobile terminal,
the equivalent biometric data in the data page of the passport, and/or
the biometric data stored in the electronic memory of the passport.

6. The method according to claim 1, which comprises, before the step of transmitting the photograph and the signature of the photograph to a remote server, a step of encrypting these data with the public key of the country selected by the user.

7. The method according to claim 1, which comprises, after the step of calculating a facial recognition template from the photograph, a step of encrypting the template and transmitting the encrypted template to the communicating mobile terminal.

8. A device for the remote signature and certification of a person's identification data, characterized in that it comprises:
a communicating mobile terminal configured to:
read a machine-readable zone, in an official document, which zone is reserved for the reading, identification and validation of this document;
read, from a memory in this official document, a photograph and a signature of said photograph; and
transmit the photograph and the signature of the photograph to a remote server; and
the remote server being configured to:
calculate a facial recognition template from the photograph;
calculate a hash of the data corresponding to the passport's data and administrative data, including the facial recognition template of the country selected by the user; and
encode the hash according to a two-dimensional code, for example a visible electronic stamp, and sign the two-dimensional code, including the template, with the certificate of the country selected by the user; and
transmit the two-dimensional code to the communicating mobile terminal.
